(19) United States
(12) Patent Application Publication
(10) Pub. No.: US 2017/0373313 A1
(43) Pub. Date: Dec. 28, 2017

(54) POSITIVE ELECTRODE ACTIVE MATERIAL FOR NON-AQUEOUS ELECTROLYTE SECONDARY CELL, METHOD FOR MANUFACTURING SAID POSITIVE ELECTRODE ACTIVE MATERIAL, CELL CONTAINING SAID POSITIVE ELECTRODE ACTIVE MATERIAL, AND METHOD FOR CHARGING CELL

(71) Applicants: YAMAHA HATSUDOKI KABUSHIKI KAISHA, Iwata-shi (JP); NATIONAL UNIVERSITY CORPORATION SHIZUOKA UNIVERSITY, Shizuoka-shi (JP)

(72) Inventors: Juichi ARAI, Shizuoka (JP); Yasumasa TOMITA, Hamamatsu-shi (JP)

(73) Assignees: YAMAHA HATSUDOKI KABUSHIKI KAISHA, Iwata-shi (JP); NATIONAL UNIVERSITY CORPORATION SHIZUOKA UNIVERSITY, Shizuoka-shi (JP)

(21) Appl. No.: 15/699,072

(22) Filed: Sep. 8, 2017

Related U.S. Application Data
(63) Continuation of application No. PCT/JP2016/056293, filed on Mar. 1, 2016.

(30) Foreign Application Priority Data
Mar. 13, 2015 (JP) 2015-051398

(51) Int. Cl. H01M 4/58; C01G 51/00; C01G 53/00; H01M 4/52; H01M 4/50; C01G 45/12; H01M 4/36; H01M 10/44; H01M 4/02

(52) U.S. Cl. CPC H01M 4/582; H01M 4/364; C01G 51/42; C01G 53/42; H01M 10/44; H01M 4/523; H01M 4/502; C01G 45/1242; C01G 53/50; C01P 2006/40; H01M 2004/021; H01M 2004/028

(57) ABSTRACT

A positive electrode active material for a non-aqueous electrolyte secondary battery includes LiX, where X represents a halogen atom.

### CROSS REFERENCE TO RELATED APPLICATIONS

This application is a continuation under 35 U.S.C. 120 of International Application PCT/JP2016/056293 having the International Filing Date of Mar. 1, 2016, and having the benefit of the earlier filing date of Japanese Application No. 2015-051398, filed Mar. 13, 2015. Each of the identified applications is fully incorporated herein by reference.

### BACKGROUND

### Technical Field

The present invention relates to a positive electrode active material for a non-aqueous electrolyte secondary battery and a manufacturing method therefor, a battery containing the positive electrode active material, and a method of charging and discharging a battery.

### Background Art

Secondary batteries, such as lithium ion secondary batteries, are widely used in small mobile device applications (Patent Literature 1, specified further on). In recent years, there has been a demand for development of a lower-cost secondary battery having higher energy density and higher capacity.

### CITATION LIST

### Patent Literature

[Patent Literature 1] JP 2006-134758 A

### SUMMARY

The inventors of the present invention have found that a low-cost battery having high capacity, high voltage, and high energy density is obtained through the use of a lithium halide (LiX) for a positive electrode active material.

The present invention provides a positive electrode active material for a non-aqueous electrolyte secondary battery capable of being used in the manufacture of a low-cost battery having high capacity, high voltage, and high energy density and a manufacturing method therefor, a battery containing the positive electrode active material, and a method of charging and discharging a battery.

In a first aspect, a positive electrode active material for a non-aqueous electrolyte secondary battery according to one embodiment of the present invention includes LiX, where X represents a halogen atom.

In a second aspect, the positive electrode active material for a non-aqueous electrolyte secondary battery according to the above-mentioned first aspect includes a mixture of: the LiX, where X represents a halogen atom; and MₓO_{y}, where M represents at least one kind selected from an alkali metal atom, an alkaline earth metal atom, a transition metal, a metal of a Group 12 element, and a metal of a Group 13 element, 0<x≦1, and 0<y≦2.

In a third aspect, in the positive electrode active material for a non-aqueous electrolyte secondary battery according to the above-mentioned second aspect, a molar ratio of LiX to MₓO_{y} in the mixture may be 0.1 or more and 100 or less.

In a fourth aspect, in the positive electrode active material for a non-aqueous electrolyte secondary battery according to the above-mentioned second and third aspects, the mixture may have an average particle diameter of 100 μm or less.

In a fifth aspect, in the positive electrode active material for a non-aqueous electrolyte secondary battery according to any one of the above-mentioned second to fourth aspects, MₓO_{y} may include BₐA_{b}O_{c}, where A represents at least one kind selected from an alkali metal atom, an alkaline earth metal atom, a transition metal other than B, a metal of a Group 12 element, and a metal of a Group 13 element, and B represents a transition metal, 0<a≦1, 0<b≦1, and 0<c≦2.

In a sixth aspect, in the positive electrode active material for a non-aqueous electrolyte secondary battery according to any one of the above-mentioned second to fourth aspects, MₓO_{y} may include BₐA_{b}D_{d}O_{c}, where A represents at least one kind selected from an alkali metal atom, an alkaline earth metal atom, a transition metal other than B, a metal of a Group 12 element, and a metal of a Group 13 element, B represents a transition metal, and D represents a transition metal other than A or B, 0<a≦1, 0≦b≦1, 0<c≦2, and 0≦d≦1.

In a seventh aspect, in the positive electrode active material for a non-aqueous electrolyte secondary battery according to any one of the above-mentioned second to sixth aspects, the mixture may form at least 50% of the positive electrode active material.

In an eighth aspect, a method of manufacturing a positive electrode active material for a non-aqueous electrolyte secondary battery according to one embodiment of the present invention includes a step of blending LiX with another substance, where X represents a halogen atom.

In a ninth aspect, in the method of manufacturing a positive electrode active material for a non-aqueous electrolyte secondary battery according to the above-mentioned eighth aspect, the blending step includes a step of mixing: first particles each formed of LiX, where X represents a halogen atom; and second particles each formed of MₓO_{y}, where M represents at least one kind selected from an alkali metal atom, an alkaline earth metal atom, a transition metal, a metal of a Group 12 element, and a metal of a Group 13 element, 0<x≦1, and 0<y≦2.

In a tenth aspect, in the method of manufacturing a positive electrode active material for a non-aqueous electrolyte secondary battery according to the above-mentioned ninth aspect, the mixing step may be performed at a speed of rotations of 100 rpm or more.

In an eleventh aspect, in the method of manufacturing a positive electrode active material for a non-aqueous electrolyte secondary battery according to the above-mentioned ninth or tenth aspects, the mixing step may provide a mixture having an average particle diameter of 100 μm or less.

In a twelfth aspect, in the method of manufacturing a positive electrode active material for a non-aqueous electrolyte secondary battery according to any one of the above-mentioned ninth to eleventh aspects, a mass ratio of the first particles to the second particles may be 0.1 or more but not more than 100.

In a thirteenth aspect, in the method of manufacturing a positive electrode active material for a non-aqueous electrolyte secondary battery according to any one of the above-mentioned ninth to twelfth aspects, MₓO_{y} may include BₐA_{b}O_{c}, where A represents at least one kind selected from an alkali metal atom, an alkaline earth metal atom, a transition metal other than B, a metal of a Group 12 element, and a metal of a Group 13 element, and B represents a transition metal, 0<a≦1, 0≦b≦1, 0<c≦2.

In a fourteenth aspect, in the method of manufacturing a positive electrode active material for a non-aqueous electrolyte secondary battery according to any one of the above-mentioned ninth to thirteenth aspects, MₓO_{y} may include BₐA_{b}D_{d}O_{c}, where A represents at least one kind selected from an alkali metal atom, an alkaline earth metal atom, a transition metal other than B, a metal of a Group 12 element, and a metal of a Group 13 element, B represents a transition metal, and D represents a transition metal other than A or B, 0<a≦1, 0≦b≦1, 0<c≦2, and 0≦d≦1.

In a fifteenth aspect, a battery according to one embodiment of the present invention includes: a positive electrode; and a negative electrode, in which the positive electrode contains the positive electrode active material for a non-aqueous electrolyte secondary battery of any one of the above-mentioned first to seventh aspects.

In a sixteenth aspect, a method of charging and discharging a battery including a positive electrode and a negative electrode according to one embodiment of the present invention includes: a charge step including causing LiX, where X represents a halogen atom, to ionize to generate Li⁺, X⁻, and an electron in the positive electrode, and causing the electron to migrate to the negative electrode; and a discharge step including causing the Li⁺ and the X⁻ to bind to each other to generate LiX in the positive electrode, and causing an electron to migrate from the negative electrode to the positive electrode.

In a seventeenth aspect, in the method of charging and discharging a battery according to the above-mentioned sixteenth aspect, in the charge step, the generated X⁻ binds to MₓO_{y}, and in the discharge step, the X⁻ separates from a bound product of the X⁻ and the MₓO_{y}.

### Advantageous Effects of Invention

The positive electrode active material for a non-aqueous electrolyte secondary battery according to any one of the above-mentioned first to seventh aspects contains LiX, and hence LiX functions as a positive electrode active material. X⁻ (anion of a halogen atom) has high electronegativity. Accordingly, in the battery according to the above-mentioned fifteenth aspect, which contains the positive electrode active material for a non-aqueous electrolyte secondary battery of any one of the above-mentioned first to seventh aspects, LiX functions as a positive electrode active material, and hence lower cost is achieved and an electrode having high voltage, high capacity, and high energy density can be formed.

The method of manufacturing a positive electrode active material for a non-aqueous electrolyte secondary battery according to any one of the above-mentioned eighth to fourteenth aspects includes the step of blending LiX with another substance, where X represents a halogen atom, and hence the positive electrode active material for a non-aqueous electrolyte secondary battery can be obtained by a simple method.

The method of charging and discharging a battery including a positive electrode and a negative electrode according to the above-mentioned sixteenth or seventeenth aspects includes: the charge step including causing LiX to ionize to generate Li⁺, X⁻, and an electron in the positive electrode, and causing the electron to migrate to the negative electrode; and the discharge step including causing the Li⁺ and the X⁻ to bind to each other to generate LiX in the positive electrode, and causing an electron to migrate from the negative electrode to the positive electrode, and hence a low-cost battery having high voltage, high capacity, and high energy density can be achieved.

### BRIEF DESCRIPTION OF THE DRAWINGS

FIG. 1 shows a formula for illustrating a reaction in a positive electrode in a battery according to one embodiment of the present invention.

FIG. 2 is a general schematic diagram for illustrating a reaction mechanism in the positive electrode in the battery according to one embodiment of the present invention.

FIG. 3 is a graph for showing X-ray diffractometry (XRD) patterns of positive electrode active materials for a non-aqueous electrolyte secondary battery according to Example 1 of the present invention.

FIG. 4 is a graph for showing discharge curves (0.1 C) of batteries using, for their positive electrodes, positive electrode active materials for a non-aqueous electrolyte secondary battery according to Example 1 of the present invention (mixture of LiF and NiO, pulverization time: 72 hours).

FIG. 5 is a graph for showing charge-discharge curves (0.1 C) of batteries using, for their positive electrodes, positive electrode active materials for a non-aqueous electrolyte secondary battery according to Example 1 of the present invention (mixture of LiF and NiO, pulverization time: 12 hours and 72 hours).

FIG. 6 is a graph for showing the XPS measurement results of Ni (2 p) contained in the positive electrode active material for a non-aqueous electrolyte secondary battery according to Example 1 of the present invention (mixture of LiF and NiO, pulverization time: 72 hours) before and after charge-discharge of a battery using the positive electrode active material for its positive electrode.

FIG. 7 is a graph for showing the XPS measurement results of 0 (1 s) contained in the positive electrode active material for a non-aqueous electrolyte secondary battery according to Example 1 of the present invention (mixture of LiF and NiO, pulverization time: 72 hours) before and after charge-discharge of a battery using the positive electrode active material for its positive electrode.

FIG. 8 is a graph for showing the XPS measurement results of F (1 s) contained in the positive electrode active material for a non-aqueous electrolyte secondary battery according to Example 1 of the present invention (mixture of LiF and NiO, pulverization time: 72 hours) before and after charge-discharge of a battery using the positive electrode active material for its positive electrode.

FIG. 9 is a graph for showing the XPS measurement results of Li (1 s) contained in the positive electrode active material for a non-aqueous electrolyte secondary battery according to Example 1 of the present invention (mixture of LiF and NiO, pulverization time: 72 hours) before and after charge-discharge of a battery using the positive electrode active material for its positive electrode.

FIG. 10 is a graph for showing the cyclic voltammetry of a battery using, for its positive electrode, a positive electrode active material for a non-aqueous electrolyte secondary battery according to Example 2 of the present invention (mixture of LiF and NiMn₂O₄, pulverization time: 72 hours).

FIG. 11 is a graph for showing discharge curves (0.1 C) of a battery using, for its positive electrode, a positive electrode active material for a non-aqueous electrolyte secondary battery according to Example 2 of the present invention (mixture of LiF and NiO, NiMn₂O₄, MnO, CoO, or Mn₂O₃, pulverization time: 72 hours).

FIG. 12 is a view for schematically illustrating the battery according to one embodiment of the present invention.

FIG. 13A and FIG. 13B each show the results of a cycle test of a battery using, for its positive electrode, the mixture according to Example 1 of the present invention (LiF:NiO=1:1 (molar ratio), pulverization time: 72 hours).

FIG. 14 is a graph for showing charge-discharge curves of batteries using, for their positive electrodes, mixtures according to Example 4 of the present invention (mixtures of LiF and NiO (LiF:NiO=70:30, 60:40, 50:50, 40:60, 30:70 (molar ratio), pulverization time: 72 hours).

FIGS. 15A, 15B and 15C are graphs for showing charge-discharge curves (FIG. 15A), XPS spectra (FIG. 15B), and XRD patterns (FIG. 15C) of a battery using, for its positive electrode, a mixture according to Example 4 of the present invention (LiF:NiO=70:30, pulverization time: 72 hours).

FIG. 16 is a graph for showing the XRD measurement results of batteries using, for their positive electrodes, mixtures according to Example 5 of the present invention (mixtures of LiF and LiₘNiₙO (LiF:LiₘNiₙO=1:1 (molar ratio), m:n=0.13:0.87, 0.10:0.90, 0.07:0.93 (molar ratio)).

FIGS. 17A and 17B are graphs for showing charge-discharge curves (FIG. 17A) and rate comparison (FIG. 17B) of batteries using the mixtures shown in FIG. 16 for their positive electrodes.

FIG. 18 is a graph for showing the XRD measurement results of batteries using, for their positive electrodes, mixtures according to Example 6 of the present invention (mixtures of LiF, NiO, and MnO (LiF:(MnO+NiO)=1:1 (molar ratio), NiO:MnO=5:5, 6:4, 7:3, 8:2 (molar ratio), pulverization time: 72 hours).

FIG. 19 shows photographs for showing the STEM measurement results of a mixture according to Example 6 of the present invention (mixture of LiF, NiO, and MnO (NiO:MnO=5:5 (molar ratio), pulverization time: 72 hours).

FIG. 20 is a graph for showing charge-discharge curves of batteries using, for their positive electrodes, mixtures according to Example 6 of the present invention (mixtures of LiF, NiO, and MnO (LiF: (NiO+MnO)=1:1 (molar ratio), Ni:Mn=5:5, 6:4, 7:3, 8:2, pulverization time: 72 hours).

FIGS. 21A, 21B and 21C are graphs for showing XPS spectra (Ni) (FIG. 21A), XPS spectra (Mn) (FIG. 21B), and charge-discharge curves (FIG. 21C) of a battery using, for its positive electrode, a mixture according to Example 6 of the present invention (mixture of LiF, NiO, and MnO (LiF: (NiO+MnO)=1:1 (molar ratio), Ni:Mn=5:5 (molar ratio), pulverization time: 72 hours).

FIG. 22 is a graph for showing the charge-discharge measurement results of a mixture according to Example 7 of the present invention (LiF—NiMn₂O₄).

FIG. 23 is a graph for showing the charge-discharge measurement results of a battery according to Example 8 of the present application (lithium ion battery including a positive electrode using the mixture according to Example 1 of the present invention, and a negative electrode using graphite carbon).

FIG. 24 is an explanatory diagram of the reaction mechanism of a battery using a positive electrode active material of the present invention.

### DETAILED DESCRIPTION

The present invention is hereinafter described in detail with reference to the drawings. In the present invention, “part(s) ” means “part (s) by mass” and “%” means “mass o” unless otherwise specified.

### 1. POSITIVE ELECTRODE ACTIVE MATERIAL

A positive electrode active material according to one embodiment of the present invention is a positive electrode active material for a non-aqueous electrolyte secondary battery (hereinafter sometimes referred to simply as “positive electrode active material”), containing LiX, where X represents a halogen atom. The positive electrode active material according to this embodiment contains LiX, and hence, in a battery using the positive electrode active material for its positive electrode, LiX ionizes to generate a lithium ion and X⁻ during discharge, and the lithium ion can bind to X⁻ to generate LiX during charge.

The positive electrode active material according to this embodiment contains a mixture of LiX, where X represents a halogen atom, and MₓO_{y}, where M represents at least one kind selected from an alkali metal atom, an alkaline earth metal atom, a transition metal, a metal of a Group 12 element, and a metal of a Group 13 element, 0<x≦1, and 0<y≦2. MₓO_{y} may contain one kind of M, or may contain a plurality of kinds of M's.

The positive electrode active material according to this embodiment contains LiX, which generates an anion of a halogen atom (X⁻) having high electronegativity through ionization, and hence through the use of the positive electrode active material according to this embodiment as a positive electrode active material, a battery having high capacity, high voltage, and high energy density can be manufactured.

More specifically, the positive electrode active material according to this embodiment contains a mixture obtained by mixing first particles (solid in the form of powdery particles) each formed of the LiX, and second particles (solid in the form of powdery particles) each formed of the MₓO_{y}. A method of mixing the first particles and the second particles is described later.

The positive electrode active material according to this embodiment can be suitably used as a positive electrode active material for a secondary battery, and can be particularly suitably used as a positive electrode active material for a non-aqueous electrolyte secondary battery.

### 1.1. Method of Charging and Discharging Battery

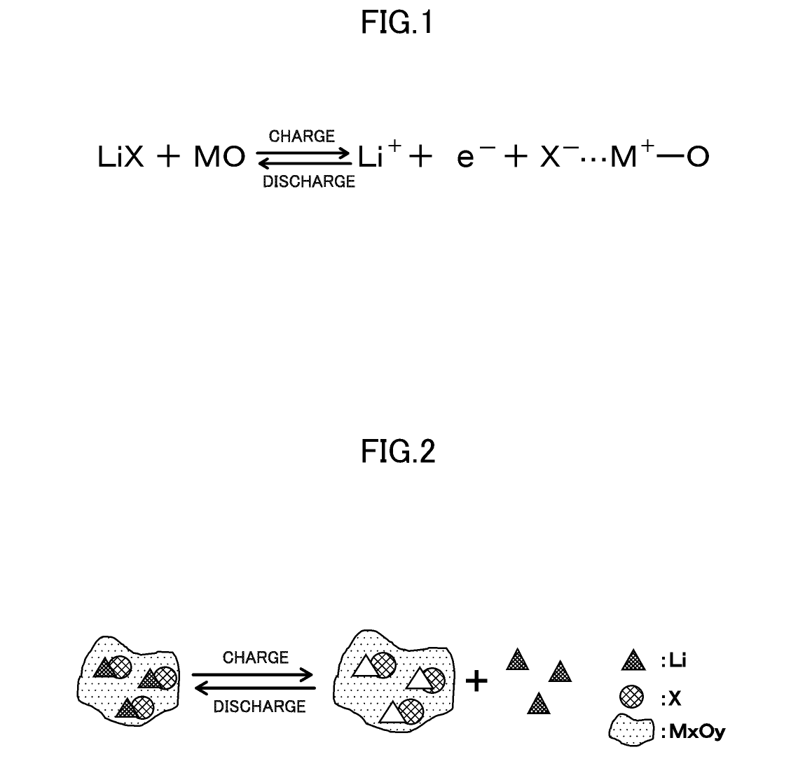

A battery (secondary battery, for example, non-aqueous electrolyte secondary battery) using the positive electrode active material according to this embodiment in its positive electrode may be charged and discharged by a reaction mechanism illustrated in FIG. 1 and FIG. 2.

For example, a method of charging and discharging a battery according to one embodiment of the present invention is a method of charging and discharging a battery including a positive electrode and a negative electrode, the method including, as illustrated in FIG. 1: a charge step including causing LiX, where X represents a halogen atom, to ionize to generate Li⁺ (lithium ion), X⁻, and an electron in the positive electrode, and causing the electron to migrate to the negative electrode; and a discharge step including causing the Li⁺ and the X⁻ to bind to each other to generate LiX in the positive electrode, and causing an electron to migrate from the negative electrode to the positive electrode. In the method of charging and discharging a battery according to this embodiment, the charge step and the discharge step are repeated.

More specifically, in the method of charging and discharging a battery according to this embodiment, as illustrated in FIG. 2, the generated X can bind to the MₓO_{y} in the charge step, and the X⁻ can separate from a bound product of the X⁻ and the MₓO_{y} in the discharge step.

As described above, in the charge step, the generated X binds to the MₓO_{y}, and thus the generated X⁻ can be trapped by the MₓO_{y}. Accordingly, in the subsequent discharge step, Li⁺ and X⁻ can be allowed to bind to each other again, and moreover, the generated X⁻ can be prevented from, for example, being released to the outside or binding to any other substance. In addition, through the binding of the generated X⁻ to the MₓO_{y}, electrical conductivity can be improved.

FIG. 24 is an explanatory diagram of a reaction mechanism of a battery using the positive electrode active material of the present invention. In FIG. 24, description is made by taking the case where LiX is LiF as an example.

As illustrated in FIG. 24, MₓO_{y} presumably has a role of stably trapping F⁻at the time of discharge to promote the reformation of LiF. For example, when the average particle diameter of the mixture according to this embodiment is decreased to shorten the distance between LiX and MₓO_{y}, X⁻ can be stably trapped to facilitate the reformation of LiX at the time of discharge. X⁻ (in particular, F⁻) has a high ionization tendency, and hence can be stably present as X⁻. Accordingly, when X⁻ can be stably trapped, the reformation of LiX at the time of discharge is facilitated.

In the positive electrode active material according to this embodiment, from the viewpoint of enabling the manufacture of a battery having higher capacity, higher density, and higher energy density, the molar ratio of LiX to MₓO_{y} in the mixture may be 0.1 or more but not more than 100, and is preferably 10 or less.

In addition, from the viewpoint of enabling the conversion from LiX to Li⁺ and X to proceed uniformly and smoothly in a battery manufactured using the positive electrode active material according to this embodiment, the average particle diameter (primary particle diameter) of the positive electrode active material according to this embodiment (the mixture) is preferably 100 μm or less, and for example, may be 100 nm or more but not more than 100 μm, or maybe less than 100 nm. In addition, from the viewpoint of shortening the distance between LiX and MₓO_{y} to stably trap X⁻, to thereby facilitate the reformation of LiX at the time of discharge, the average particle diameter (primary particle diameter) of particles in the mixture is preferably less than 100 nm, more preferably less than 50 nm, still more preferably less than 30 nm.

For example, through the adjustment of the diameters of balls to be used for a ball mill, the mixture having a particle diameter of less than 100 nm may be obtained.

### 1.2. LiX

Examples of the halogen atom contained in LiX include a fluorine atom, a chlorine atom, a bromine atom, and an iodine atom. An anion of the halogen atom has high electronegativity, and hence can provide a battery having high energy density and that easily forms binding between itself and a metal oxide (MₓO_{y}). Accordingly, at the time of the operation of a battery using the positive electrode active material according to this embodiment for its electrode (positive electrode), through the binding of the anion of the halogen atom to the metal oxide in the positive electrode, the anion of the halogen atom can be stably retained in the positive electrode even under a high-temperature condition. In particular, X preferably represents a fluorine atom from the viewpoint of having higher electronegativity, and hence being able to provide a battery being more excellent in operation stability under a high-temperature condition and having higher energy density.

### 1.3. Metal Oxide (MₓO_{y})

M contained in the metal oxide MₓO_{y} represents at least one kind selected from an alkali metal atom (e.g., Li, Na, or K), an alkaline earth metal atom (e.g., Mg, Ca, Sr, or Ba), a transition metal (Ni, Co, Ru, Ir, V, Fe, Ti, Cr, Mo, W, Zr, Mn, Pd, Pt, Fe, Cu, Ag, or Au), a metal of a Group 12 element (e.g., Zn, Cd, or Hg), and a metal of a Group 13 element (e.g., Al, Ga, In, or Tl). In particular, it is preferred that M contained in the metal oxide MₓO_{y} contain Ni from the viewpoint that a battery having high capacity can be obtained. For example, it is more preferred that M contain Ni, and Co and/or Mn. In addition, it is preferred that x and y of MₓO_{y} satisfy 0<x and 0<y, respectively.

More specifically, MₓO_{y} is preferably BₐA_{b}O_{c}, where A represents at least one kind selected from an alkali metal atom, an alkaline earth metal atom, a transition metal other than B, a metal of a Group 12 element, and a metal of a Group 13 element, and B represents a transition metal, 0<a≦1, 0≦b≦1, and 0<c≦2. For example, MₓO_{y} is preferably NiₐA_{b}O_{c}, where A represents at least one kind selected from an alkali metal atom, an alkaline earth metal atom, a transition metal other than Ni, a metal of a Group 12 element, and a metal of a Group 13 element, 0<a≦1, 0≦b≦1, and 0<c≦2.

In addition, for example, MₓO_{y} is preferably BₐA_{b}D_{d}O_{c}, where A represents at least one kind selected from an alkali metal atom, an alkaline earth metal atom, a transition metal other than B, a metal of a Group 12 element, and a metal of a Group 13 element, B represents a transition metal, and D represents a transition metal other than A or B, 0<a≦1, 0≦b≦1, 0<c≦2, and 0≦d≦1. In this case, specific examples of the various kinds of metals represented as A, B, and D are as described above.

The positive electrode active material according to this embodiment preferably contains (e.g., is formed or constituted by) 50% or more of the mixture of LiX and MₓO_{y}.

### 1.4. Action and Effect

The positive electrode active material according to this embodiment contains the mixture of LiX and MₓO_{y}, and hence when the positive electrode active material is used for, for example, a positive electrode, LiX functions as a positive electrode active material. X⁻ (anion of a halogen atom) has high electronegativity. Accordingly, through the use of LiX as a positive electrode active material, lower cost is achieved and an electrode having high voltage, high capacity, and high energy density can be formed.

### 2. METHOD OF MANUFACTURING POSITIVE ELECTRODE ACTIVE MATERIAL

The positive electrode active material according to the above-mentioned embodiment may be obtained by the following manufacturing method. That is, a method of manufacturing a positive electrode active material according to one embodiment of the present invention (hereinafter sometimes referred to simply as “manufacturing method”) includes a step of blending (e.g., using) LiX, where X represents a halogen atom, with another substance. In this case, the blending step may be a step of blending LiX as a solid. In addition, in this case, LiX may have the form of particles.

More specifically, the blending step includes a step of mixing: first particles each formed of LiX, where X represents a halogen atom; and second particles each formed of MₓO_{y}, where M represents at least one kind selected from an alkali metal atom, an alkaline earth metal atom, a transition metal, a metal of a Group 12 element, and a metal of a Group 13 element, 0<x≦1, and 0<y≦2. Through the mixing step, a mixture (having an average particle diameter of 100 μm or less, preferably 100 nm or more but not more than 100 μm) of the first particles and the second particles can be obtained.

In the manufacturing method according to this embodiment, from the viewpoint of enabling uniform dispersion of the first particles and the second particles, the mixing step is preferably performed at a speed of rotations of 100 rpm or more, preferably 100 rpm or more but not more than 1,500 rpm (more preferably 1,000 rpm or less). Through the mixing of the first particles and the second particles at the above-mentioned speed of rotations, the first particles and the second particles can be pulverized.

In the manufacturing method according to this embodiment, from the viewpoint of enabling uniform dispersion of the first particles and the second particles, the mass ratio of the first particles to the second particles is preferably 0.001 or more but not more than 1,000.

In the manufacturing method according to this embodiment, from the viewpoint of enabling uniform dispersion the first particles in the mixture, the average particle diameter of the first particles is preferably 100 nm or more but not more than 100 μm.

In the manufacturing method according to this embodiment, from the viewpoint of enabling uniform dispersion the second particles in the mixture, the average particle diameter of the second particles is preferably 100 nm or more but not more than 100 μm.

In addition, in the manufacturing method according to this embodiment, a mixing time in the mixing step is generally 1 hour or more but not more than 500 hours, and a mixing temperature in the mixing step is generally 10° C. or more but not more than 60° C. (in terms of ambient temperature).

The method of manufacturing a positive electrode active material according to this embodiment includes the step of blending LiX, where X represents a halogen atom, into the positive electrode material, and hence lower cost is achieved and a positive electrode active material for forming an electrode having high voltage, high capacity, and high energy density can be obtained by a simple method. More specifically, the blending step includes a step of mixing first particles each formed of LiX, and second particles each formed of MₓO_{y}, and hence the positive electrode active material containing the mixture of LiX and MₓO_{y} can be obtained by a simpler method.

### 2. BATTERY

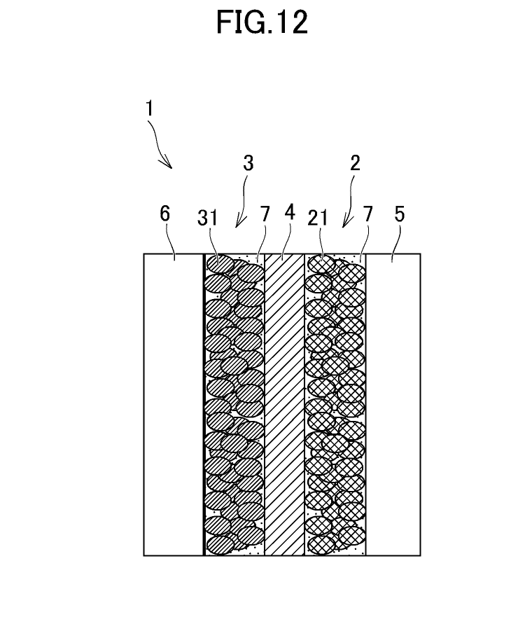

FIG. 12 is a view for schematically illustrating an example of a battery according to one embodiment of the present invention using the positive electrode active material according to the above-mentioned embodiment. As illustrated in FIG. 12, the battery according to this embodiment includes a positive electrode 2 and a negative electrode 3, and the positive electrode 2 contains the positive electrode active material according to the above-mentioned embodiment.

The battery according to this embodiment is preferably a secondary battery from the viewpoint of being capable of being charged and discharged, and is more preferably a non-aqueous electrolyte secondary battery from the viewpoint of the positive electrode active material containing LiX. The battery according to this embodiment may contain the positive electrode active material according to the above-mentioned embodiment as a positive electrode active material in its positive electrode.

As an example of the battery according to this embodiment, a lithium ion secondary battery is schematically illustrated in FIG. 12. As illustrated in FIG. 12, a lithium ion secondary battery (hereinafter referred to simply as “battery”) 1 includes a positive electrode layer (positive electrode) 2, a negative electrode layer (negative electrode) 3, a separator 4, a positive electrode-side collector 5, and a negative electrode-side collector 6.

### 2.1. Positive Electrode

The positive electrode layer 2 includes an electrode material (positive electrode material) 21 containing the positive electrode active material according to the above-mentioned embodiment, and an electrolyte solution 7 filling gaps between particles of the positive electrode material 21.

The positive electrode layer 2 may contain a conductive material in addition to the positive electrode material 21. A known substance is used as the conductive material, and for example, carbon black and acetylene black are each used as a carbon-based conductive material. The positive electrode layer 2 may contain one kind or a plurality of kinds of conductive materials.

The positive electrode layer 2 may further contain a binder. As the binder, various polymers that have heretofore been used as binders may be adopted. Specific examples of the polymer include polyvinyl alcohol, polyethylene terephthalate, polypropylene glycol, and a styrene-butadiene rubber. The positive electrode layer 2 may contain one kind or a plurality of kinds of binders.

### 2.2. Negative Electrode

The negative electrode layer 3 includes an electrode material (negative electrode material) 31 containing the negative electrode active material, and the electrolyte solution 7 filling gaps between particles of the negative electrode material 31.

As the negative electrode active material, a substance that is known as a substance used for a lithium ion secondary battery may be adopted. Specific examples thereof include carbon (e.g., graphite), metal lithium, Sn, and SiO.

The negative electrode layer 3 may further contain the binder described above as a material that may be used for the positive electrode layer 2.

The electrolyte solution 7 contains a solvent and an electrolyte dissolved in the solvent.

As the solvent, a known solvent that is used for a lithium ion secondary battery may be adopted. A non-aqueous solvent, that is, an organic solvent is used as the solvent. Examples of the non-aqueous solvent include carbonates, such as ethylene carbonate, dimethyl carbonate, ethyl methyl carbonate, diethyl carbonate, and propylene carbonate. One kind or a mixture of a plurality of kinds of those solvents may be used.

As the electrolyte, a substance that has heretofore been used as an electrolyte of a lithium ion secondary battery may be adopted. More specific examples of the electrolyte include LiPF₆, LiClO₄, and LiBF₄. The electrolyte solution 7 may contain one kind or a plurality of kinds of electrolytes.

In order to improve the stability of the performance of the battery and its electrical characteristics, any of various additives, such as overcharge inhibitors, may be added to the electrolyte solution 7.

### 2.3. Separator

The separator 4 is arranged between the positive electrode layer 2 and the negative electrode layer 3. The arrangement of the separator 4 between the positive electrode layer 2 and the negative electrode layer 3 can prevent a short circuit between the positive electrode and the negative electrode. In addition, when the separator 4 is porous, the electrolyte solution 7 and lithium ions can be allowed to permeate therethrough. As a material for the separator 4, for example, there are given resins (specifically, polyolefin-based polymers, such as polyethylene, polypropylene, and polystyrene).

As the positive electrode-side collector 5, for example, a metal foil of aluminum, an aluminum alloy, or the like may be used. In addition, as the negative electrode-side collector 6, for example, a metal foil of copper, a copper alloy, or the like may be used.

The battery 1 may include, in addition to the above-mentioned components, components such as a battery case, a positive electrode-side terminal, and a negative electrode-side terminal (none of which is shown). For example, a roll body formed by rolling the stack structure illustrated in FIG. 12 in many layers may be housed in a battery case. In addition, the positive electrode-side terminal is connected to the positive electrode-side collector 5, and the negative electrode-side terminal is connected to the negative electrode-side collector 6.

### 2.4. Applications

The battery according to this embodiment is low cost and has high capacity, high voltage, and high energy density, and hence can be suitably used as, for example, not only a battery for a small mobile device, but also a battery for a large machine, for example, an electric bicycle, a two-wheeler, a vehicle, or a ship.

### 3. EXAMPLES

The present invention is hereinafter described in more detail by way of Examples with reference to the drawings. However, the present invention is by no means limited to the Examples.

### 3.1. Example 1

LiF (average particle diameter: 1 μm) and NiO (average particle diameter: 10 μm) were used as raw materials, and the raw materials

(LiF: 1 g, NiO: 2.3 g) (molar ratio: about 1:1) were mixed and pulverized with a planetary ball mill to prepare a mixture. In this case, pulverization conditions were set to 650 rpm and 1 hour (h) to 144 hours (h), and for a heat-treated sample, firing was performed at from 200° C. to 800° C. under the air.

The resultant mixture was evaluated by XRD, X-ray photoelectron spectroscopy (XPS), scanning electron microscopy (SEM), cyclic voltammetry (CV), and charge-discharge measurement. In each of the CV and the charge-discharge measurement, the resultant mixture (90 g) was composited with Ketjenblack (KB) (5 g), and then the resultant composite was mixed with polyvinylidene difluoride (PVDF) to prepare a positive electrode active material (mixture:KB:PVDF=70:20:10 (mass ratio)). The positive electrode active material was applied onto an aluminum foil to prepare a working electrode (positive electrode). Metal lithium was used for a counter electrode (negative electrode), 1 M LiPF₆EC:DEC (1:1) was used for an electrolyte solution, and a cell was produced using a bipolar cell made of stainless steel.

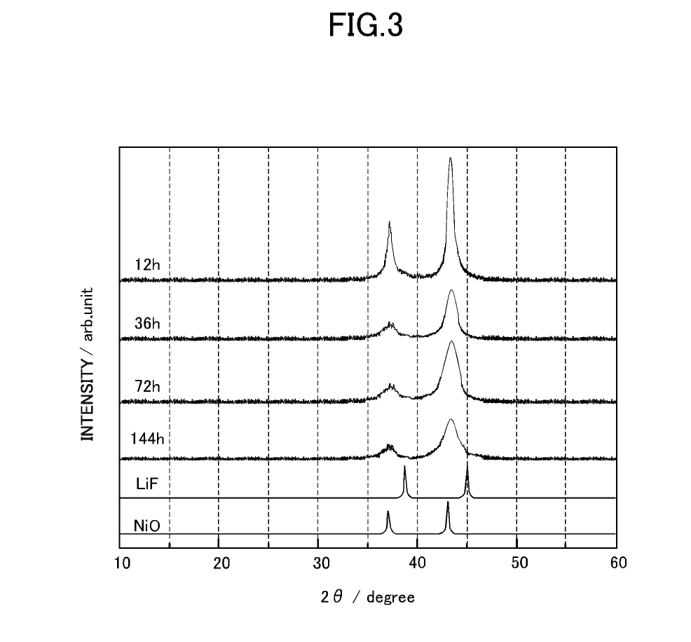

In FIG. 3, XRD patterns of the positive electrode active materials according to this Example produced in different pulverization times are shown. As shown in FIG. 3, all the observed diffraction peaks agreed with the diffraction peaks of NiO serving as a raw material, and the peaks of LiF disappeared. In addition, no diffraction peak other than those of NiO was observed. Thus, it can be understood that no crystalline compound has been newly generated.

In addition, as shown in FIG. 3, the diffraction peaks of NiO become broader along with an increase in pulverization time, indicating a decrease in particle diameter of NiO. However, the shift of the peaks is slight, and hence it is presumed that definite solid dissolution of LiF into NiO has not occurred.

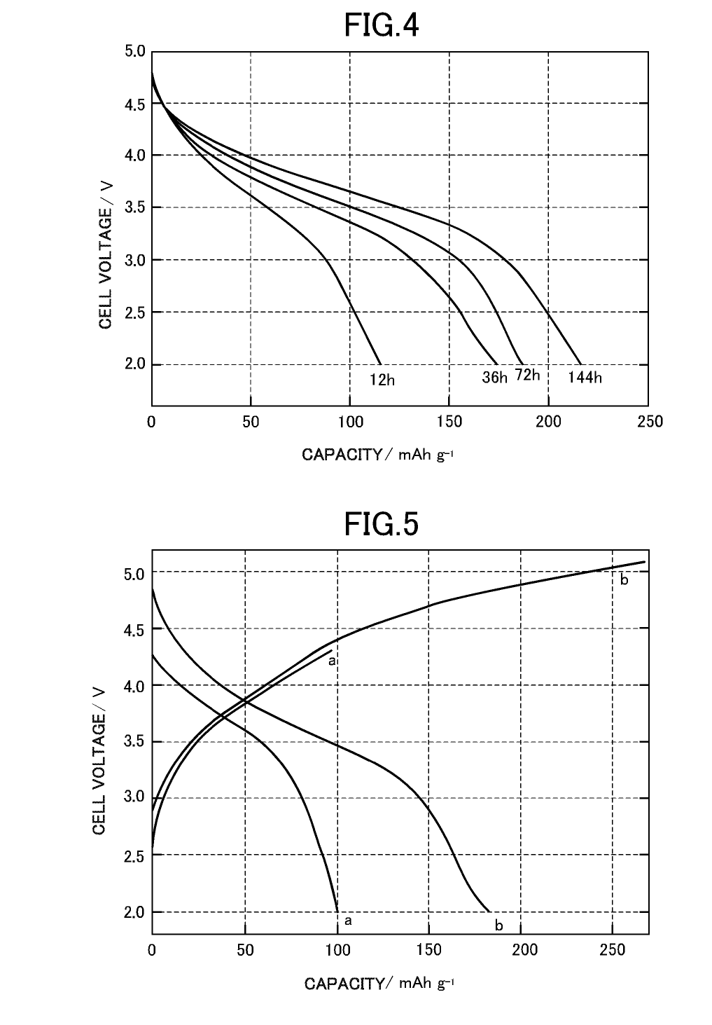

In FIG. 4, discharge curves (0.1 C) of batteries using, as their positive electrodes, the positive electrode active materials according to this Example are shown. As shown in FIG. 4, when the pulverization time was 12 hours, the discharge capacity was about 116 mAh/g, but an increase in pulverization time improved charge-discharge characteristics. When the pulverization time was 144 hours, the average voltage was 3.53 V and the discharge capacity achieved a value of 217 mAh/g corresponding to 81% of the theoretical capacity.

It can be understood from this Example that charge-discharge characteristics can be improved by increasing the pulverization time. It can be understood from the results shown in Table 1 that the particle diameter (primary particle diameter) of a sample to be obtained can be decreased by increasing the pulverization time.

TABLE 1

| Pulverization | Particle diameter |
|---|---|
| time (hours) | of mixture (μm) |
| 12 | 10 |
| 36 | 9 |
| 72 | 8 |
| 144 | 5 |

In addition, in FIG. 5, charge-discharge curves (0.1 C) of batteries using, for their positive electrodes, the positive electrode active materials according to this Example (mixture of LiF and NiO) are shown. In FIG. 5, “a” and “b” represent the cases of using, as the positive electrode active materials, the mixtures obtained in pulverization times of 12 hours and 72 hours, respectively. In addition, in FIG. 5, extending from the lower left to the upper right are charge curves, and extending from the upper left to the lower right are discharge curves.

In the batteries according to this Example, through the use of the mixtures of LiX and MₓO_{y} as positive electrode active materials, operation starting from charge has been enabled as in a general lithium secondary battery.

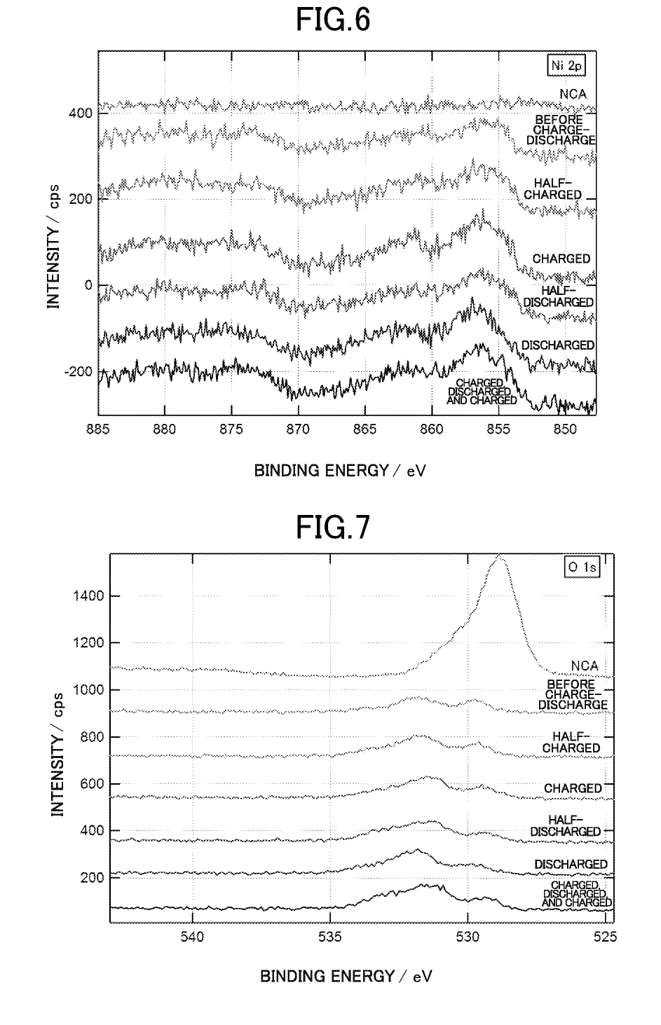

In addition, FIG. 6 to FIG. 9 are graphs for showing the results of X-ray Photoelectron Spectroscopy (XPS) measurement of Ni (2p), 0 (1 s), F (1 s), and Li (1 s), respectively, which are contained in the positive electrode active material for a non-aqueous electrolyte secondary battery according to Example 1 of the present invention (mixture of LiF and NiO, pulverization time: 72 hours) during, and before and after charge-discharge of a battery using the positive electrode active material for its positive electrode. In FIG. 6 to FIG. 10, “half-charged” means “after half charge”, “charged” means “after charge”, “half-discharged” means “after half discharge”, “discharged” means “after discharge”, and “charged, discharged, and charged” means “after charge, subsequent discharge, and subsequent charge”.

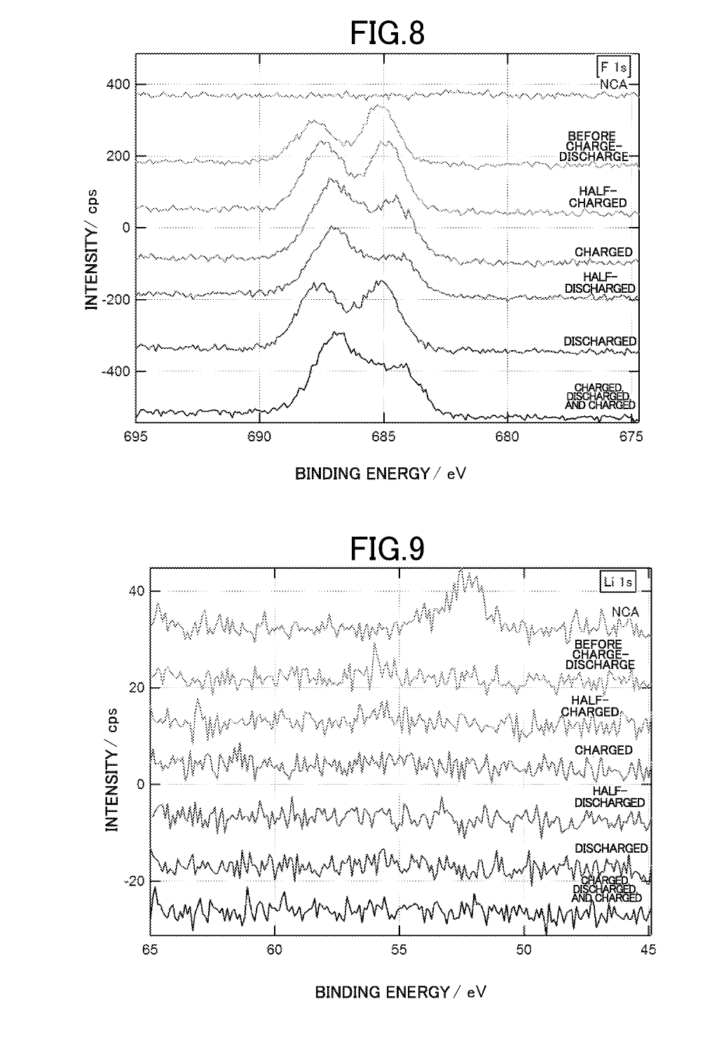

As apparent from FIG. 6 to FIG. 9, in the XPS of Ni (2 p), 0 (1 s), and Li (1 s) shown in FIG. 6, FIG. 7, and FIG. 9, no large shift was found in the spectra during, and before and after charge-discharge, whereas in the XPS of F (1 s) shown in FIG. 8, a shift was found in the spectrum during, and before and after charge-discharge. The results suggest that the reaction illustrated in FIG. 1 and FIG. 2 has occurred in the positive electrode of the battery according to this Example during, and before and after charge-discharge, and consequently, the state of a fluorine ion (anion of a halogen atom) has changed.

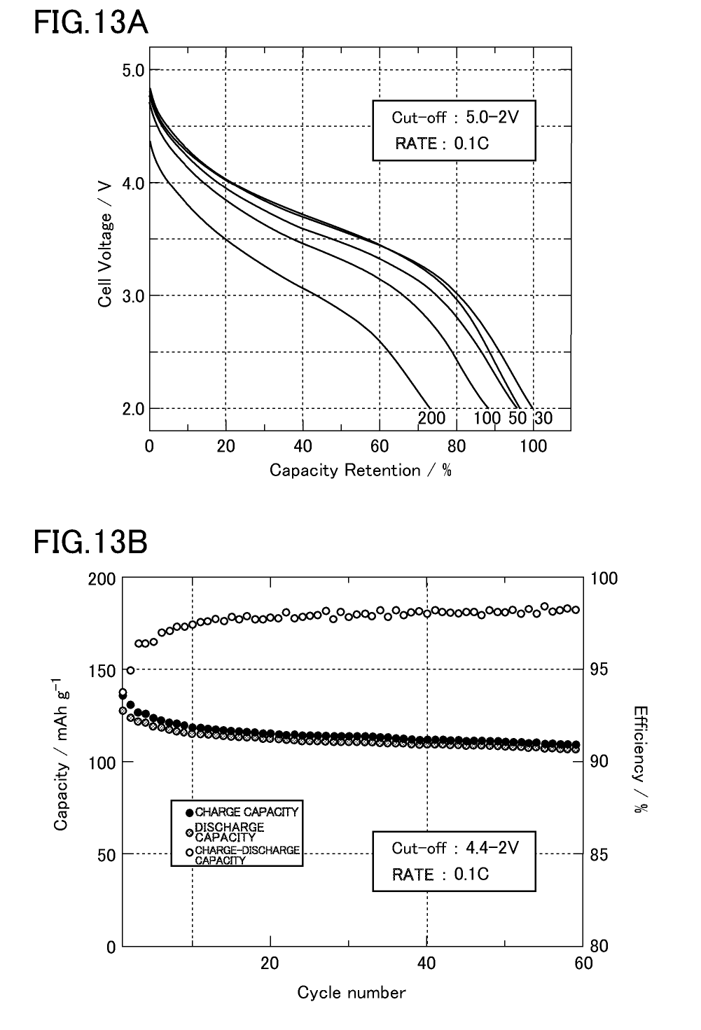

In FIG. 13A, the results of a cycle test of a battery using, for its positive electrode, the mixture according to Example 1 of the present invention (LiF:NiO=1:1, pulverization time: 72 hours, average particle diameter (primary particle diameter): 100 nm to 300 nm) (cut-off: 5.0-2 V, rate: 0.1 C) are shown. In FIG. 13A, the axis of abscissa represents capacity retention (%), the axis of ordinate represents cell voltage (V), and “30”, “50”, “100”, and “200” each represent a cycle number. It is found from FIG. 13A that the battery retained 70% or more of its original capacity even at a charge-discharge cycle number of 200.

In FIG. 13B, changes in capacity of the battery shown in FIG. 13A at charge-discharge cycle numbers of from 0 to 60 are shown (cut-off: 4.4-2 V, rate: 0.1 C, the axis of abscissa represents cycle number, and the axis of ordinate represents capacity). As shown in FIG. 13B, it is found that the battery maintains more than 95% of its original capacity when the battery is at a charge-discharge cycle number of 60.

### 3.2. Example 2

10 g of NiO (average particle diameter: 100 μm) and 21 g of Mn₂O₃ (average particle diameter: 300 μm) were mixed in a mortar at a molar ratio of 1:1, fired at 800° C., and then mixed and fired again under the same conditions to synthesize NiMn₂O₄. To the resultant NiMn₂O₄, LiF was added (NiMn₂O₄:LiF=1:4 (molar ratio)), followed by mixing and pulverization with a planetary ball mill at 650 rpm for 72 hours to provide a mixture according to this Example (average particle diameter (primary particle diameter): 200 μm).

The resultant mixture was composited with Ketjenblack (KB) at 300 rpm for 30 minutes, and the resultant composite was mixed with PVDF to prepare a positive electrode active material according to this Example. The positive electrode active material was applied onto an aluminum foil, and the resultant combination was used as a working electrode (positive electrode) to produce a battery. Metal lithium was used for a counter electrode (negative electrode), 1 M LiPF₆EC (ethylene carbonate) :DEC (diethyl carbonate) (1:1) was used for an electrolyte solution, and a cell was produced using a bipolar cell made of stainless steel.

The resultant mixture was evaluated by CV and charge-discharge measurement. In addition, besides NiMn₂O₄, mixtures of CoO, MnO, or Mn₂O₃with LiF (molar ratio: 1:1) were produced by the same procedure as that of Example 1 and were evaluated.

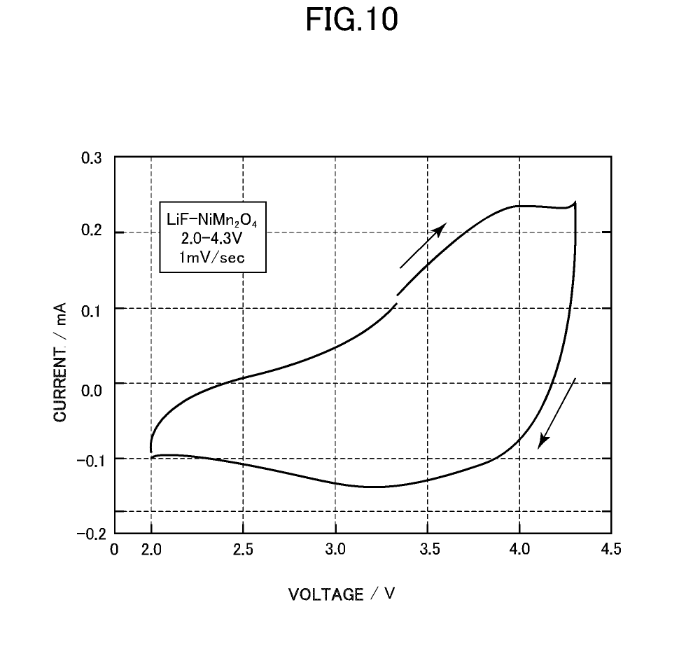

In FIG. 10, the results of CV measurement using an electrode sheet of NiMn₂O₄:LiF=1:4 (molar ratio) as a working electrode (positive electrode) are shown. Referring to FIG. 10, an increase in positive current is found from about 3 V when the potential is swept in the positive direction. The increase is considered to be an oxidation current peak corresponding to a charge reaction of the battery. In addition, a negative current flows when the potential is swept from 4.3 V in the negative direction. This current cycle is reversible without changing even when repeated, and hence the negative current is considered to correspond to a discharge reaction of the battery.

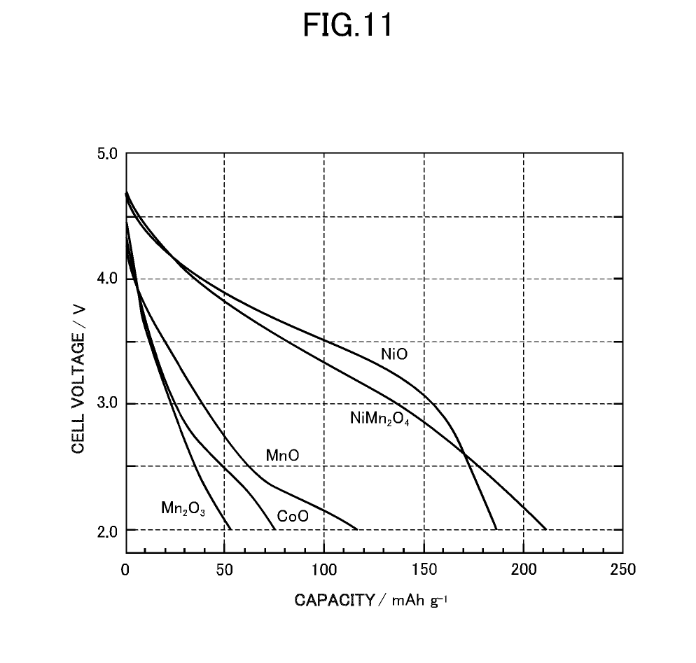

In FIG. 11, discharge curves of batteries using the respective positive electrode active materials according to this Example are shown. In a comparison made under the condition of a pulverization time of 72 hours, in the case of using NiO, a discharge capacity of 187 mAh/g was obtained, whereas in the cases of using CoO and MnO, which are divalent oxides like NiO, the discharge capacities were 75 mAh/g and 118 mAh/g, respectively and the discharge voltages were also lower than that of NiO. In addition, in the case of using Mn₂O₃, the discharge capacity was 53 mAh/g. In contrast, in the case of using spinel NiMn₂O₄, the discharge capacity was 211 mAh/g, i.e., high discharge capacity was obtained.

It was confirmed from the results shown in FIG. 11 that the oxides containing nickel exhibited high discharge capacity. In addition, the discharge capacity for NiMn₂O₄ cannot be described on the basis of the discharge by Ni³⁺→Ni²⁺ alone, and a contribution by Ni⁴⁺→Ni²⁺ is conceivable.

### 3.3. Example 3

Compounds shown in Table 2 below were mixed with LiF to prepare mixtures, and electrodes were produced by using the mixtures by the same method as that of Example 2 above. The maximum discharge capacity in each example is also shown in Table 2.

TABLE 2

| Compound | Discharge capacity (maximum) |
|---|---|
| LiNi_{0.8}Co_{0.15}Al_{0.05}O₂ | 260 mAh/g (2.0 V cut-off) |
| | 215 mAh/g (2.5 V cut-off) |
| LiMn₂O₄ | 150 mAh/g (2.5 V cut-off) |
| LiCoO₂ | 165 mAh/g (2.5 V cut-off) |
| LiNi_{0.33}Mn_{0.33}Co_{0.33}O₂ | 185 mAh/g (2.5 V cut-off) |

### 3.4. Example 4

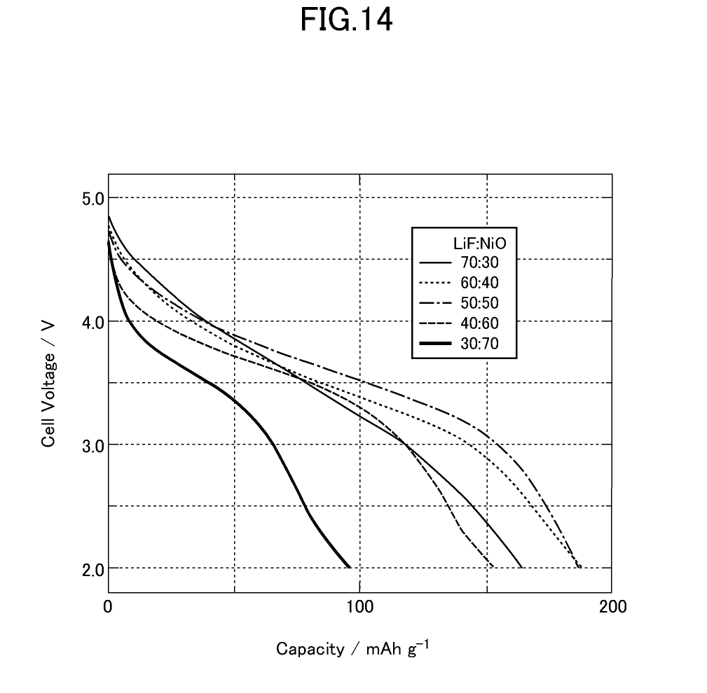

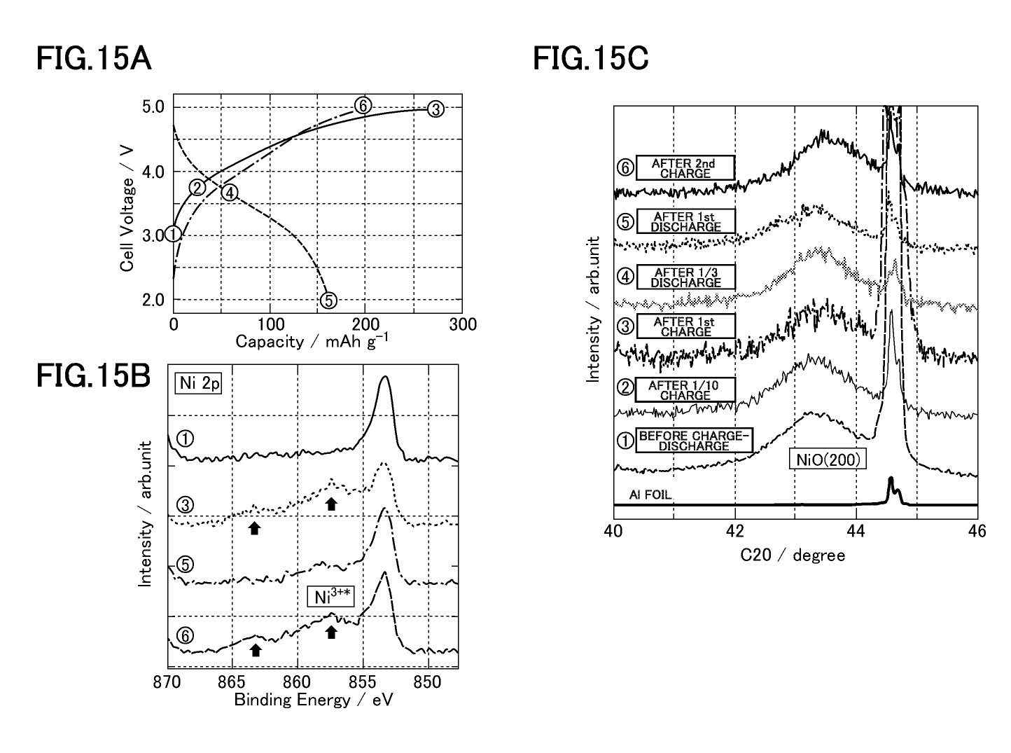

A mixture according to this Example (average particle diameter (primary particle diameter): 100 nm to 500 nm) was prepared by the same method as that of Example 1 (pulverization time: 72 hours) except that the ratio (molar ratio) of LiF and NiO serving as raw materials was changed. The results are shown in FIG. 14 and FIG. 15.

In FIG. 14, the results of rate characteristics of batteries using, for their positive electrodes, mixtures according to Example 1 of the present invention (LiF:NiO=70:30, 60:40, 50:50, 40:60, 30:70, pulverization time: 72 hours, average particle diameter (primary particle diameter): 100 nm) are shown (cut-off: 2-5 V, the axis of abscissa represents capacity, and the axis of ordinate represents cell voltage). In FIG. 14, 1C was 87%, and 5C was 62%.

It is found from FIG. 14 that the capacity tends to become lower in each of the case where the ratio of LiX to MₓO_{y} (NiO) is less than 1/1 and the case where the ratio is 6/4 or more.

In addition, in FIGS. 15, charge-discharge curves (FIG. 15A), XPS spectra (FIG. 15B), and XRD patterns (FIG. 15C) of a battery using, for its positive electrode, a mixture according to this Example (LiF:NiO=70:30, pulverization time: 72 hours) are shown. In FIG. 15A to FIG. 15C, (1) indicates a result obtained before charge-discharge, (2) indicates a result obtained after 1/10 charge, (3) indicates a result obtained at the completion of the first time of charge, (4) indicates a result obtained after the completion of the first time of charge and after the first time of 1/3 discharge, (5) indicates a result obtained at the completion of the first time of discharge, and (6) indicates a result obtained after the completion of the first time of discharge and at the completion of the second time of charge.

As is apparent from FIG. 15B (the axis of abscissa represents binding energy, and the axis of ordinate represents intensity), peaks appeared in (3), i.e., at the completion of the first time of charge and in (6), i.e., at the completion of the second time of charge (portions indicated by the arrows of FIG. 15B). The peaks indicated by the arrows are presumably those of NiO.

### 3.5. Example 5

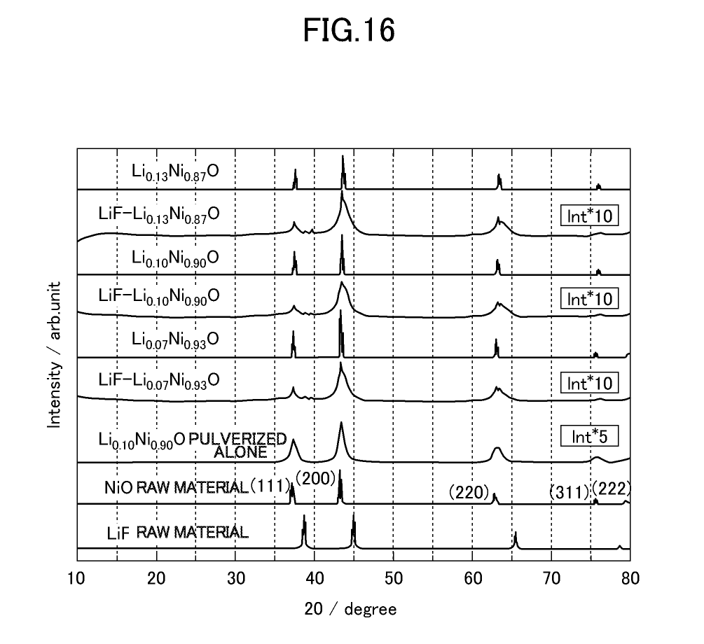

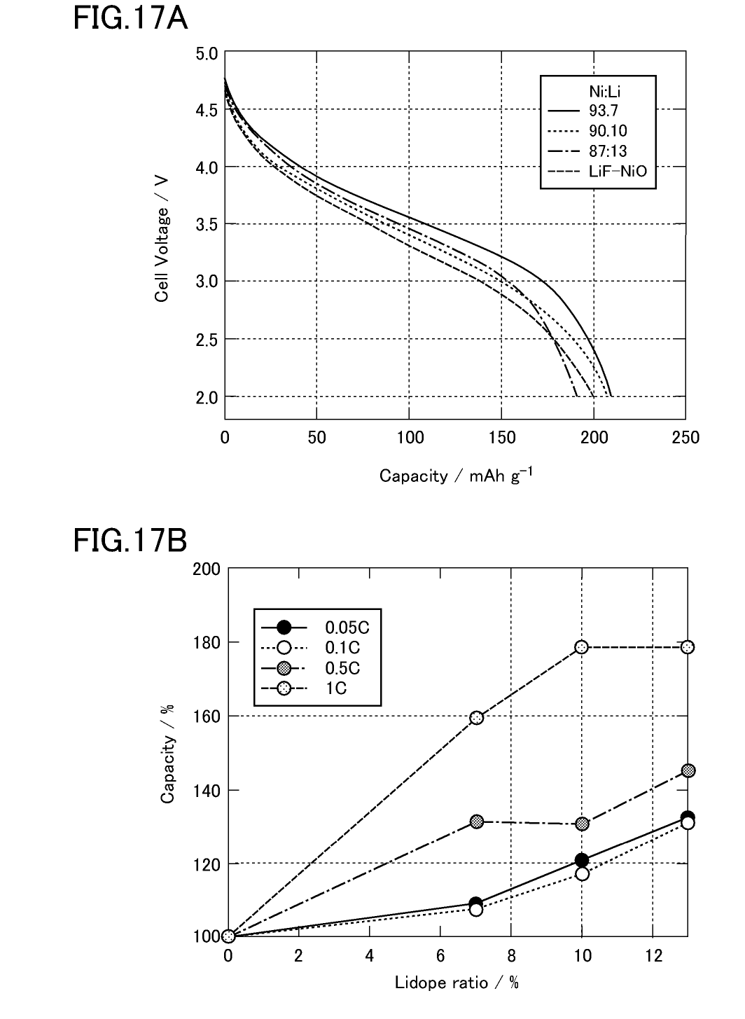

Lithium carbonate and nickel oxide (NiO) were weighed out and mixed at a predetermined molar ratio, and fired in the air to provide LiₘNiₙO, where n=1−m. The LiₘNiₙO and LiF were mixed at a predetermined molar ratio, and mixed and pulverized with a planetary ball mill to prepare a mixture according to this Example (average particle diameter (primary particle diameter): 100 nm). The results are shown in FIG. 16, FIG. 17A, and FIG. 17B.

In addition, the mixture of this Example and Ketjenblack serving as a conductive material were weighed out at a ratio of 85:10, and mixed in a mortar for 20 minutes. After that, 5 mass % of PVDF dissolved in a solvent serving as a binder was added to form the mixture into a slurry, which was applied onto an aluminum foil and vacuum-dried at room temperature to produce a positive electrode.

In FIG. 16, the XRD measurement results of batteries using, for their positive electrodes, mixtures according to this Example (mixtures of LiF and LiₘNiₙO (LiF:LiₘNiₙO=1:1 (molar ratio), m:n=0.13:0.87, 0.10:0.90, 0.07:0.93 (molar ratio)) are shown. In FIG. 17A and FIG. 17B, discharge curves (the axis of abscissa represents capacity, and the axis of ordinate represents cell voltage) and capacity ratios with respect to capacity at various rates (the axis of abscissa represents Li dope ratio, and the axis of ordinate represents capacity) of the mixtures according to this Example are shown, respectively.

In FIG. 16, diffraction patterns of NiO and LiF serving as raw materials, LiₘNiₙO obtained by firing NiO and LiF at predetermined molar ratios in the air, samples obtained by mixing and pulverizing LiF and LiₘNiₙO, and a sample obtained by pulverizing the LiₘNiₙO obtained through the firing in the air alone without the addition of LiF are shown.

As apparent from FIG. 16, after the firing in the air, the peaks of LiF have disappeared and only the peaks of NiO are found, and hence it is presumed that no compound has been newly generated. In addition, it is found that as the amount of Li in LiₘNiₙO increases (as m increases), a peak shift toward higher angles becomes larger.

Meanwhile, in the diffraction peaks of the samples obtained by mixing and pulverization with the addition of LiF, only the peaks of NiO are found, and hence it is presumed that no compound has been newly generated. In addition, when only LiₘNiₙO was pulverized alone, no peak shift occurred, whereas a peak shift occurred in each of the samples obtained by adding LiF to LiₘNiₙO, followed by mixing and pulverization. This peak shift is presumably due to the solid dissolution of LiF.

It is found from FIG. 17A that when a metal compound doped with Li (LiₘNiₙO) is used, the potential increases as compared to a non-doped sample.

In addition, in FIG. 17B, capacity against the amount of Li doping when the discharge capacity at 0.05 C is defined as 100% is shown. As apparent from FIG. 17B, the lowering of the capacity of the sample not doped with Li is remarkable at 0.5 C and 1 C. Thus, it is found that the characteristics of a battery can be enhanced through the use of NiO doped with Li as a raw material.

### 3.6. Example 6

LiF (average particle diameter: 1μm), NiO (average particle diameter: 10 μm), and MnO (average particle diameter: 10 μm) were used as raw materials, and the raw materials (molar ratio of LiF and NiO: 1:1, molar ratio of Ni and Mn: 5:5, 6:4, 7:3, 8:2) were mixed and pulverized with a planetary ball mill (pulverization conditions: 650 rpm, 3 hours (h)) to prepare a mixture. Then, the mixture was subjected to vacuum annealing at 800° C. for 6 hours. After that, the mixture was mixed and pulverized (pulverization conditions: 650 rpm, 72 hours (h)) with a planetary ball mill to prepare a mixture as a final product (average particle diameter (primary particle diameter): 100 nm to 300 nm).

The resultant mixture was evaluated by XRD, charge-discharge measurement, and STEM. The resultant mixture (90 g) was composited with Ketjenblack (KB) (5 g), and then the resultant composite was mixed with polyvinylidene difluoride (PVDF) to prepare a positive electrode material (mixture:KB:PVDF=70:20:10 (mass ratio)). The positive electrode material was applied onto an aluminum foil, and then vacuum-dried at room temperature to prepare a working electrode (positive electrode). Metal lithium was used for a counter electrode (negative electrode), 1 M LiPF₆EC:DEC (1:1) was used for an electrolyte solution, and a cell was produced using a bipolar cell made of stainless steel.

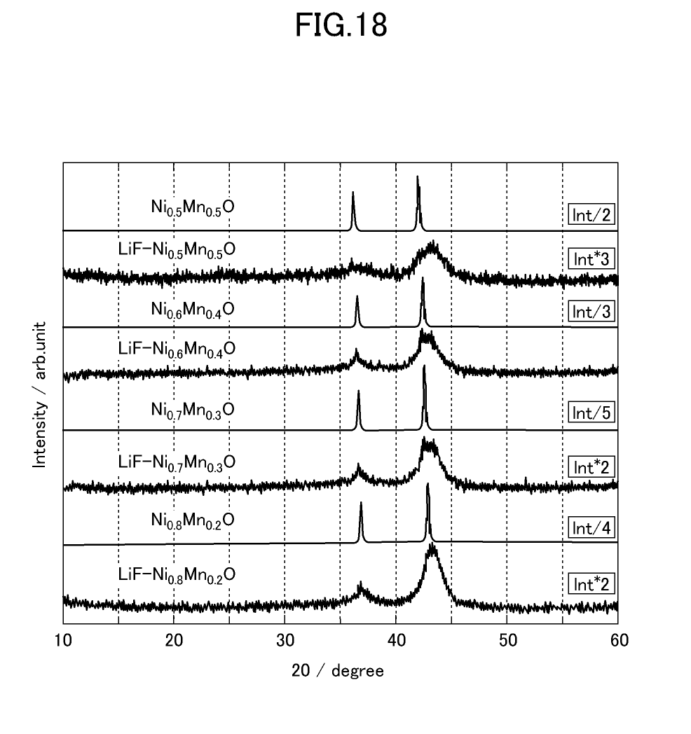

In FIG. 18, the XRD measurement results of mixtures according to this Example (LiF: (NiO+MnO)=1:1 (molar ratio), Ni:Mn=5:5, 6:4, 7:3, 8:2 (molar ratio)) are shown.

Although not shown, for a sample obtained by merely mixing NiO and MnO for 3 hours, peaks substantially the same as the peaks of NiO and MnO serving as raw materials were detected. In addition, in the mixture after vacuum annealing, the formation of a solid solution was found. In addition, in FIG. 18, in the mixtures after 72 hours of mixing and pulverization, the peaks of LiF had disappeared and a shift toward higher angles was found. Thus, it is presumed that a solid solution of LiF and NiₓM₁₋ₓO, where 0<x<1, has been formed.

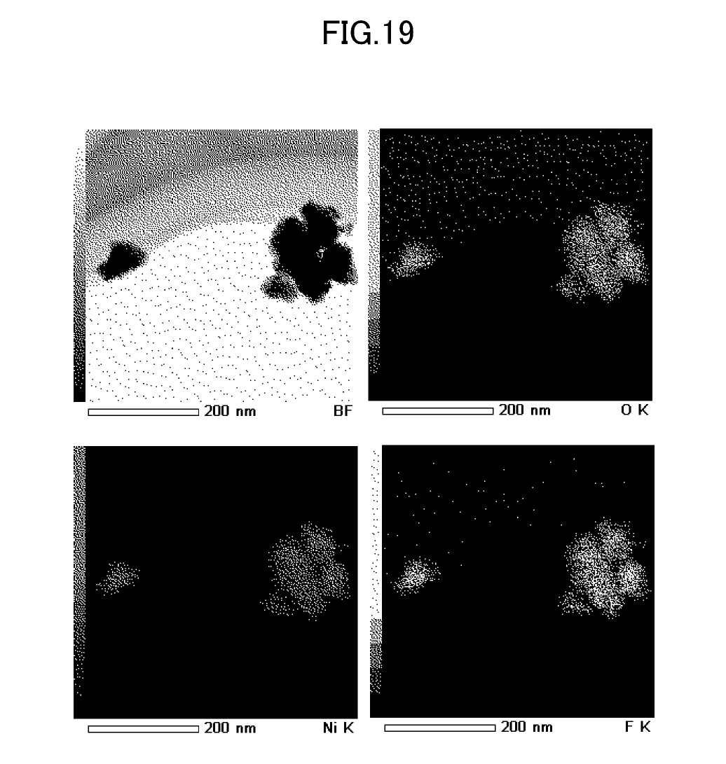

In FIG. 19, the STEM measurement results of the mixture according to this Example are shown. As shown in FIG. 19, no deviation was observed for any of Ni, O, and F. This also allows the presumption that a solid solution of LiF and NiₓM₁₋ₓO, where 0<x<1, has been formed.

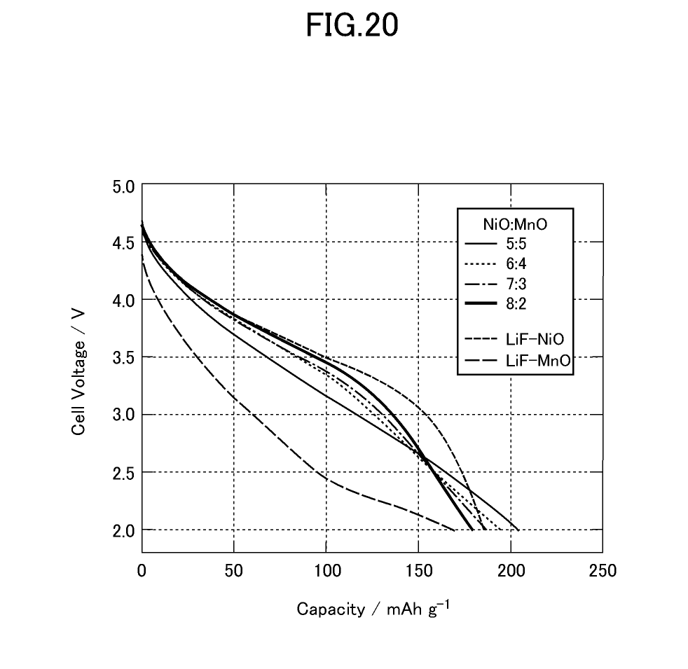

In FIG. 20, charge-discharge curves of batteries using, for their positive electrodes, mixtures according to this Example (mixtures of LiF, NiO, and MnO, pulverization time: 72 hours, NiO:MnO=5:5, 6:4, 7:3, 8:2) are shown. In FIG. 20, a dashed line shown as LiF-NiO represents a sample obtained by mixing LiF and NiO for 72 hours with a planetary ball mill, and a dashed line shown as LiF-MnO represents a sample obtained by mixing LiF and MnO for 72 hours with a planetary ball mill.

It can be understood from FIG. 20 that the capacity tends to be higher at a higher ratio of Mn in the mixture, and the potential tends to be higher at a higher ratio of Ni in the mixture.

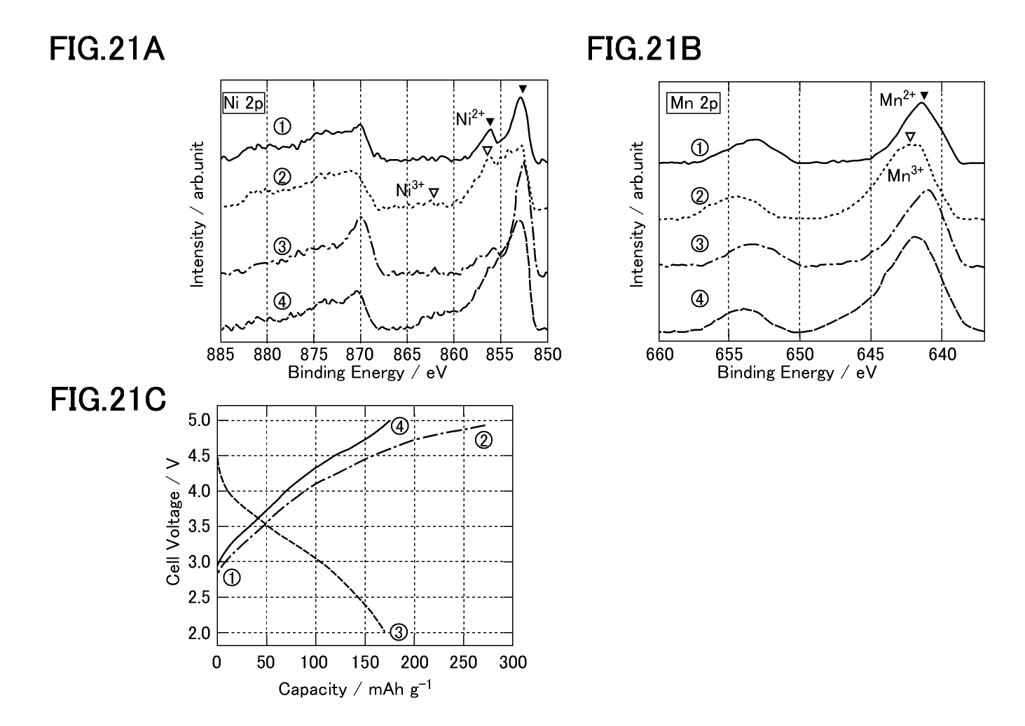

In FIGS. 21A, 21B and 21 C, XPS spectra (Ni) (FIG. 21A), XPS spectra (Mn) (FIG. 21B), and charge-discharge curves (FIG. 21C) of batteries using, for their positive electrodes, the mixtures according to this Example (using, as raw materials, LiF:(NiO+MnO)=1:1, NiO:MnO=70:30) are shown.

As is apparent from FIG. 21A and FIG. 21B, only the peaks of Ni²⁺ and Mn²⁺ appear before charge-discharge (1), the peaks of Ni³⁺ and Mn³⁺ appear after charge (2), the peaks of Ni³⁺ and Mn³⁺ disappear after discharge (3), and then the peaks of Ni³⁺ and Mn³⁺ appear again after recharge (4). This allows the presumption that a reaction between Ni^{2°}, Mn²⁺ (divalent) and Ni³⁺, Mn³⁺ (trivalent) occurs in charge-discharge.

### 3.7. Example 7

The ratio (molar ratio) of NiO (average particle diameter: 10 μm) and MnO (average particle diameter: 10 μm) serving as raw materials was set to 1/2, and the same treatment as that of Example 6 described above was performed to prepare a mixture according to this Example. In addition, a cell was produced by the same treatment as that of Example 6 described above. The resultant mixture was evaluated by charge-discharge measurement.

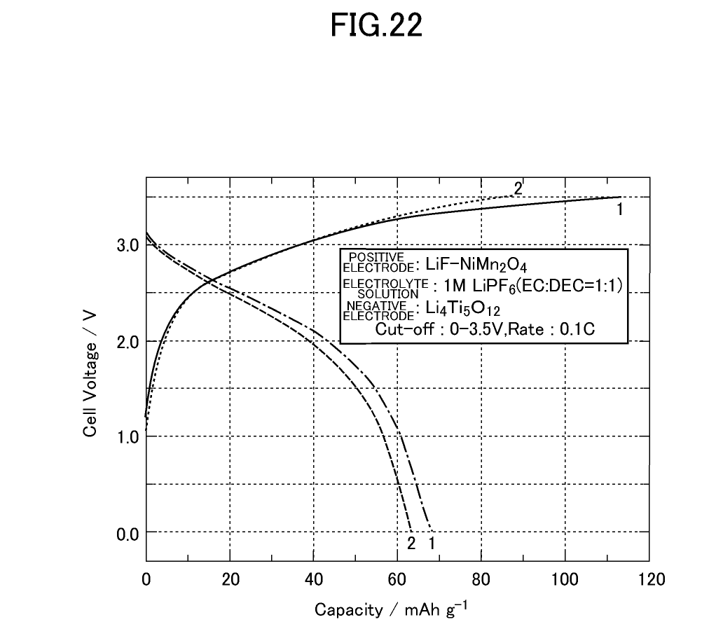

In FIG. 22, the charge-discharge measurement results of the mixture according to this Example (LiF-NiMn₂O₄) are shown. In the charge-discharge measurement shown in FIG. 22, results for a battery using Li₄Ti₅O₁₂ for its negative electrode are shown. In FIG. 22, “1” represents the first time of discharge (charge), and “2” represents the second time of discharge (charge).

### 3.8. Example 8

A cell using a positive electrode using the mixture according to Example 1 above and a negative electrode using graphite carbon was produced. The positive electrode was produced by the same method as the method by which production was performed in Example 1 above.

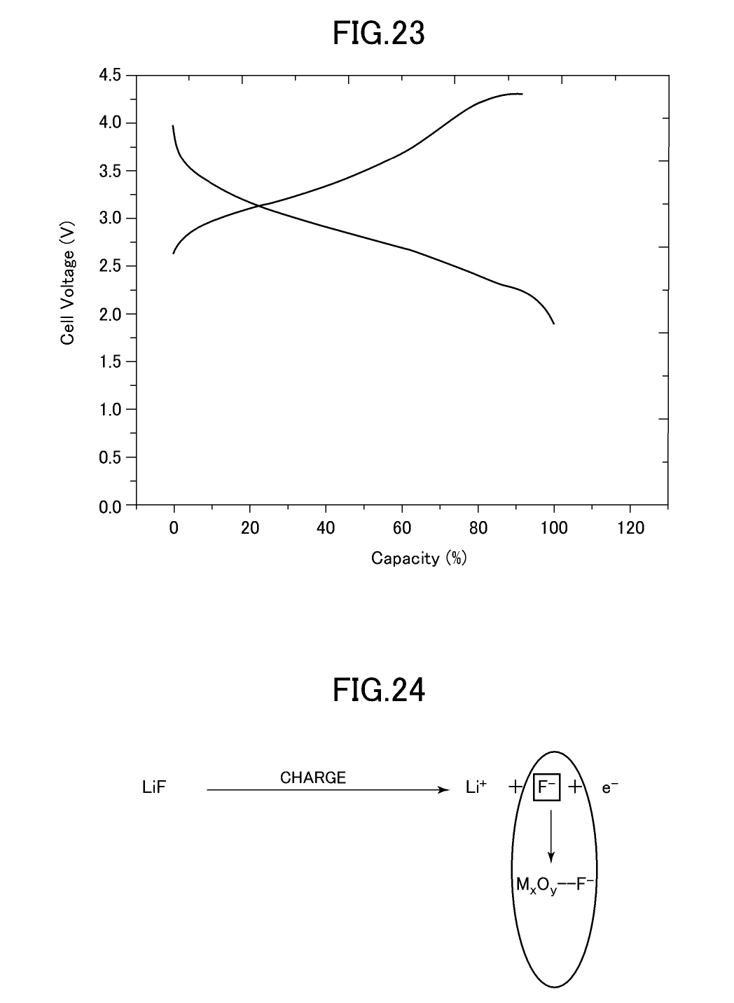

In FIG. 23, the charge-discharge measurement results of a lithium ion battery including a positive electrode using the mixture according to Example 1 of the present invention, and a negative electrode using graphite carbon are shown. It can be understood from FIG. 23 that even when graphite carbon is used for a negative electrode, satisfactory charge-discharge characteristics can be exhibited.

### 3.9. Example 9

Lif (average particle diameter: 100 nm to 100 μm), NiO (average particle diameter: 100 nm to 100 μm), and MnO (average particle diameter: 10 nm to 100 μm) are used as raw materials, and the raw materials (molar ratio of LiF and NiO: 0.5:1 to 5:1) are mixed and pulverized under an argon atmosphere with a ball mill, a wet ball mill (pulverization conditions: 300 rpm to 1,500 rpm, 0.5 hour (h) to 96 hours (h)) to prepare a mixture (average particle diameter (primary particle diameter): 10 nm to 1,000 nm).

### INDUSTRIAL APPLICABILITY

The positive electrode active material of the present invention enables the manufacture of a low-cost battery having high capacity, high voltage, and high energy density, and hence can be suitably used, for example, as a positive electrode active material in an electrode (positive electrode) included in a battery for not only a small mobile device, but also a large machine, for example, an electric bicycle, a two-wheeler, a vehicle, or a ship.

What is claimed is:

1. A positive electrode active material for a non-aqueous electrolyte secondary battery, comprising LiX, where X represents a halogen atom.

2. The positive electrode active material for a non-aqueous electrolyte secondary battery according to claim 1, wherein the positive electrode active material comprises a mixture of:
the LiX; and
MₓO_{y}, where M represents at least one kind selected from an alkali metal atom, an alkaline earth metal atom, a transition metal, a metal of a Group 12 element, and a metal of a Group 13 element, 0<x≦1, and 0<y≦2.

3. The positive electrode active material for a non-aqueous electrolyte secondary battery according to claim 2, wherein a molar ratio of LiX to MₓO_{y} in the mixture is 0.1 or more but not more than 100.

4. The positive electrode active material for a non-aqueous electrolyte secondary battery according to claim 2, wherein the mixture has an average particle diameter of 100 μm or less.

5. The positive electrode active material for a non-aqueous electrolyte secondary battery according to claim 2, wherein MₓO_{y} comprises BₐA_{b}O_{c}, where A represents at least one kind selected from an alkali metal atom, an alkaline earth metal atom, a transition metal other than B, a metal of a Group 12 element, and a metal of a Group 13 element, and B represents a transition metal, 0<a≦1, 0≦b≦1, and 0<c≦2.

6. The positive electrode active material for a non-aqueous electrolyte secondary battery according to claim 2, wherein MₓO_{y} comprises BₐA_{b}D_{d}O_{c}, where A represents at least one kind selected from an alkali metal atom, an alkaline earth metal atom, a transition metal other than B, a metal of a Group 12 element, and a metal of a Group 13 element, B represents a transition metal, and D represents a transition metal other than A or B, 0<a≦1, 0≦b≦1, 0<c≦2, and 0≦d≦1.

7. The positive electrode active material for a non-aqueous electrolyte secondary battery according to claim 2, wherein the mixture forms at least 50% of the positive electrode active material .

8. A method of manufacturing a positive electrode active material for a non-aqueous electrolyte secondary battery, the method comprising a step of blending LiX with another substance, where X represents a halogen atom.

9. The method of manufacturing a positive electrode active material for a non-aqueous electrolyte secondary battery according to claim 8, wherein the blending step includes a step of mixing:
first particles each formed of LiX, where X represents a halogen atom; and
second particles each formed of MₓO_{y}, where M represents at least one kind selected from an alkali metal atom, an alkaline earth metal atom, a transition metal, a metal of a Group 12 element, and a metal of a Group 13 element, 0<x≦1, and 0<y≦2.

10. The method of manufacturing a positive electrode active material for a non-aqueous electrolyte secondary battery according to claim 9, wherein the mixing step is performed at a speed of rotations of 100 rpm or more.

11. The method of manufacturing a positive electrode active material for a non-aqueous electrolyte secondary battery according to claim 9, wherein the mixing step provides a mixture having an average particle diameter of 100 μm or less.

12. The method of manufacturing a positive electrode active material for a non-aqueous electrolyte secondary battery according to claim 9, wherein a mass ratio of the first particles to the second particles is 0.1 or more but not more than 100.

13. The method of manufacturing a positive electrode active material for a non-aqueous electrolyte secondary battery according to claim 9, wherein MₓO_{y} comprises BₐA_{b}O_{c}, where A represents at least one kind selected from an alkali metal atom, an alkaline earth metal atom, a transition metal other than B, a metal of a Group 12 element, and a metal of a Group 13 element, and B represents a transition metal, 0<a≦1, 0≦b≦1, and 0<c≦2.

14. The method of manufacturing a positive electrode active material for a non-aqueous electrolyte secondary battery according to claim 9, wherein MₓO_{y} comprises BₐA_{b}D_{d}O_{c}, where A represents at least one kind selected from an alkali metal atom, an alkaline earth metal atom, a transition metal other than B, a metal of a Group 12 element, and a metal of a Group 13 element, B represents a transition metal, and D represents a transition metal other than A or B, 0<a≦1, 0≦b≦1, 0<c≦2, and 0≦d≦1.

15. A battery, comprising:
a positive electrode; and
a negative electrode,
wherein the positive electrode contains the positive electrode active material for a non-aqueous electrolyte secondary battery of claim 1.

16. A method of charging and discharging a battery including a positive electrode and a negative electrode, the method comprising:
a charge step including causing LiX, where X represents a halogen atom, to ionize to generate Li⁺, X⁻, and an electron in the positive electrode, and causing the electron to migrate to the negative electrode; and
a discharge step including causing the Li⁻ and the X⁻ to bind to each other to generate LiX in the positive electrode, and causing an electron to migrate from the negative electrode to the positive electrode.

17. The method of charging and discharging a battery according to claim 16,
wherein in the charge step, the generated X binds to MₓO_{y}, and
wherein in the discharge step, the X⁻ separates from a bound product of the X and the MₓO_{y}.

18. The positive electrode active material for a non-aqueous electrolyte secondary battery according to claim 3, wherein the mixture has an average particle diameter of 100 μm or less.

19. The positive electrode active material for a non-aqueous electrolyte secondary battery according to claim 3, wherein MₓO_{y} comprises BₐA_{b}O_{c}, where A represents at least one kind selected from an alkali metal atom, an alkaline earth metal atom, a transition metal other than B, a metal of a Group 12 element, and a metal of a Group 13 element, and B represents a transition metal, 0<a≦1, 0≦b≦1, and 0<c≦2.

20. The positive electrode active material for a non-aqueous electrolyte secondary battery according to claim 4, wherein MₓO_{y} comprises BₐA_{b}O_{c}, where A represents at least one kind selected from an alkali metal atom, an alkaline earth metal atom, a transition metal other than B, a metal of a Group 12 element, and a metal of a Group 13 element, and B represents a transition metal, 0<a≦1, 0≦b≦1, and 0<c≦2.

21. The positive electrode active material for a non-aqueous electrolyte secondary battery according to claim 3, wherein MₓO_{y} comprises BₐA_{b}D_{d}O_{c}, where A represents at least one kind selected from an alkali metal atom, an alkaline earth metal atom, a transition metal other than B, a metal of a Group 12 element, and a metal of a Group 13 element, B represents a transition metal, and D represents a transition metal other than A or B, 0<a≦1, 0≦b≦1, 0<c≦2, and 0≦d≦1.

22. The positive electrode active material for a non-aqueous electrolyte secondary battery according to claim 4, wherein MₓO_{y} comprises BₐA_{b}D_{d}O_{c}, where A represents at least one kind selected from an alkali metal atom, an alkaline earth metal atom, a transition metal other than B, a metal of a Group 12 element, and a metal of a Group 13 element, B represents a transition metal, and D represents a transition metal other than A or B, 0<a≦1, 0≦b≦1, 0<c≦2, and 0≦d≦1.

23. The positive electrode active material for a non-aqueous electrolyte secondary battery according to claim 3, wherein the mixture forms at least 50% of the positive electrode active material.

24. The positive electrode active material for a non-aqueous electrolyte secondary battery according to claim 4, wherein the mixture forms at least 50% of the positive electrode active material.

25. The positive electrode active material for a non-aqueous electrolyte secondary battery according to claim 5, wherein the mixture forms at least 50% of the positive electrode active material.

26. The positive electrode active material for a non-aqueous electrolyte secondary battery according to claim 6, wherein the mixture forms at least 50% of the positive electrode active material .

27. The method of manufacturing a positive electrode active material for a non-aqueous electrolyte secondary battery according to claim 10, wherein the mixing step provides a mixture having particles with an average particle diameter of 100 μm or less.

28. The method of manufacturing a positive electrode active material for a non-aqueous electrolyte secondary battery according to claim 10, wherein a mass ratio of the first particles to the second particles is 0.1 or more but not more than 100.

29. The method of manufacturing a positive electrode active material for a non-aqueous electrolyte secondary battery according to claim 11, wherein a mass ratio of the first particles to the second particles is 0.1 or more but not more than 100.

30. The method of manufacturing a positive electrode active material for a non-aqueous electrolyte secondary battery according to claim 10, wherein MₓO_{y} comprises BₐA_{b}O_{c}, where A represents at least one kind selected from an alkali metal atom, an alkaline earth metal atom, a transition metal other than B, a metal of a Group 12 element, and a metal of a Group 13 element, and B represents a transition metal, 0<a≦1, 0≦b≦1, and 0<c≦2.

31. The method of manufacturing a positive electrode active material for a non-aqueous electrolyte secondary battery according to claim 11, wherein MₓO_{y} comprises BₐA_{b}O_{c}, where A represents at least one kind selected from an alkali metal atom, an alkaline earth metal atom, a transition metal other than B, a metal of a Group 12 element, and a metal of a Group 13 element, and B represents a transition metal, 0<a≦1, 0≦b≦1, and 0<c≦2.

32. The method of manufacturing a positive electrode active material for a non-aqueous electrolyte secondary battery according to claim 12, wherein MₓO_{y} comprises BₐA_{b}O_{c}, where A represents at least one kind selected from an alkali metal atom, an alkaline earth metal atom, a transition metal other than B, a metal of a Group 12 element, and a metal of a Group 13 element, and B represents a transition metal, 0<a≦1, 0≦b≦1, and 0<c≦2.

33. The method of manufacturing a positive electrode active material for a non-aqueous electrolyte secondary battery according to claim 10, wherein MₓO_{y} comprises BₐA_{b}D_{d}O_{c}, where A represents at least one kind selected from an alkali metal atom, an alkaline earth metal atom, a transition metal other than B, a metal of a Group 12 element, and a metal of a Group 13 element, B represents a transition metal, and D represents a transition metal other than A or B, 0<a≦1, 0≦b≦1, 0<c≦2, and 0≦d≦1.

34. The method of manufacturing a positive electrode active material for a non-aqueous electrolyte secondary battery according to claim 11, wherein MₓO_{y} comprises BₐA_{b}D_{d}O_{c}, where A represents at least one kind selected from an alkali metal atom, an alkaline earth metal atom, a transition metal other than B, a metal of a Group 12 element, and a metal of a Group 13 element, B represents a transition metal, and D represents a transition metal other than A or B, 0<a≦1, 0≦b≦1, 0<c≦2, and 0≦d≦1.

35. The method of manufacturing a positive electrode active material for a non-aqueous electrolyte secondary battery according to claim 12, wherein MₓO_{y} comprises BₐA_{b}D_{d}O_{c}, where A represents at least one kind selected from an alkali metal atom, an alkaline earth metal atom, a transition metal other than B, a metal of a Group 12 element, and a metal of a Group 13 element, B represents a transition metal, and D represents a transition metal other than A or B, 0<a≦1, 0≦b≦1, 0<c≦2, and 0≦d≦1.

36. The method of manufacturing a positive electrode active material for a non-aqueous electrolyte secondary battery according to claim 13, wherein MₓO_{y} comprises BₐA_{b}D_{d}O_{c}, where A represents at least one kind selected from an alkali metal atom, an alkaline earth metal atom, a transition metal other than B, a metal of a Group 12 element, and a metal of a Group 13 element, B represents a transition metal, and D represents a transition metal other than A or B, 0<a≦1, 0≦b≦1, 0<c≦2, and 0≦d≦1.

37. A battery, comprising:
a positive electrode; and
a negative electrode,
wherein the positive electrode contains the positive electrode active material for a non-aqueous electrolyte secondary battery of claim 2.

38. A battery, comprising:
a positive electrode; and
a negative electrode,
wherein the positive electrode contains the positive electrode active material for a non-aqueous electrolyte secondary battery of claim 3.

39. A battery, comprising:
a positive electrode; and
a negative electrode,
wherein the positive electrode contains the positive electrode active material for a non-aqueous electrolyte secondary battery of claim 4.

40. A battery, comprising:
a positive electrode; and
a negative electrode,
wherein the positive electrode contains the positive electrode active material for a non-aqueous electrolyte secondary battery of claim 5.

41. A battery, comprising:
a positive electrode; and
a negative electrode,
wherein the positive electrode contains the positive electrode active material for a non-aqueous electrolyte secondary battery of claim 6.

42. A battery, comprising:
a positive electrode; and
a negative electrode,
wherein the positive electrode contains the positive electrode active material for a non-aqueous electrolyte secondary battery of claim 7.
